(19) United States
(12) Patent Application Publication
(10) Pub. No.: US 2008/0159278 A1
(43) Pub. Date: Jul. 3, 2008

(54) Multiplexer To Transmitter Interface Protocol

(76) Inventors: Sajith Balraj, San Diego, CA (US); Kenton A. Younkin, San Diego, CA (US); Bruce Collins, San Diego, CA (US); Robert Riley, Escondido, CA (US); Ben A. Saidi, San Diego, CA (US); Jai N. Subrahmanyam, Houston, TX (US)

Correspondence Address: QUALCOMM INCORPORATED, 5775 MOREHOUSE DR., SAN DIEGO, CA, 92121, US

(21) Appl. No.: 11/739,603

(22) Filed: Apr. 24, 2007

Related U.S. Application Data
(60) Provisional application No. 60/794,460, filed on Apr. 24, 2006.

(51) Int. Cl. H04Q 11/00

(52) U.S. Cl. 370/388

(57) ABSTRACT

Multiplexer to transmitter interface protocol. A method for a data interface protocol is provided that includes receiving a first packet stream having at least one overhead information symbol (OIS) group and at least one multicast logical channel (MLC) group, and mapping each OIS group to an OIS descriptor packet and at least one OIS payload packet. The method also includes mapping each MLC group to an MLC descriptor packet and at least one MLC payload packet, and outputting the OIS descriptor, OIS payload, MLC descriptor, and MLC payload packets in a second packet stream. An apparatus includes input logic to receive the first packet stream, processing logic to map each OIS group to an OIS descriptor packet an OIS payload packet, and each MLC group to an MLC descriptor packet and an MLC payload packet, and output logic to output the mapped packets in a second packet stream.

### CLAIM OF PRIORITY UNDER 35 U.S.C. §119

The present Application for Patent claims priority to Provisional Application No. 60/794,460 entitled “MUX TO TRANSMITTER INTERFACE (MTI) PROTOCOL” filed Apr. 24, 2006, and assigned to the assignee hereof and hereby expressly incorporated by reference herein.

### BACKGROUND

1. Field

The present application relates generally to the operation of communication networks, and more particularly, to a multiplexer to transmitter interface protocol for use in a communication network.

2. Background

Data networks, such as wireless communication networks, have to trade off between services customized for a single terminal and services provided to a large number of terminals. For example, the distribution of multimedia content to a large number of resource limited portable devices (subscribers) is a complicated problem. Therefore, it is important for network administrators, content retailers, and service providers to have a way to distribute content and/or other network services in a fast and efficient manner and in such a way as to increase bandwidth utilization and power efficiency.

In typical wireless delivery systems, content providers provide content for distribution to devices over a multicast transmission channel. Typically the content comprises video, audio and/or other multimedia content streams and associated overhead information. The content from all providers is assembled and multiplexed together at a central location, such as an aggregation site. From this central location the content is conveyed to multiple transmitter sites for transmission to devices over one or more multicast channels. For example, a large number of transmitter sites may be used to transmit the multiplexed content to a large number of devices over a wide area.

Unfortunately, if the means used to convey the multiplexed content to the transmitter sites is inefficient many undesirable results may occur that may degrade overall system performance. For example, time synchronization of the content streams may be disturbed or latencies may be introduced that result in an unsatisfying experience for device users.

Therefore, it would be desirable to have a system that operates to provide a fast and efficient interface to allow multiplexed content streams to be conveyed between an aggregation site and a large number of transmitter sites.

### SUMMARY

In one or more aspects, a multiplexer to transmitter interface (MTI) system, comprising methods and apparatus, is provided that operates to allow multiplexed content streams to be efficiently conveyed between an aggregation site and a large number of transmitter sites in a communication network.

In an aspect, a method for a data interface protocol is provided. The method comprises receiving a first packet stream comprising at least one overhead information symbol (OIS) group and at least one multicast logical channel (MLC) group, and mapping each OIS group to an OIS descriptor packet and at least one OIS payload packet. The method also comprises mapping each MLC group to an MLC descriptor packet and at least one MLC payload packet, and outputting the OIS descriptor packet, the OIS payload packet(s), the MLC descriptor packet, and the MLC payload packet(s) in a second packet stream.

In an aspect, an apparatus for a data interface protocol is provided. The apparatus comprises packet input logic configured to receive a first packet stream comprising at least one OIS group and at least one MLC group. The apparatus also comprises packet processing logic configured to map each OIS group to an OIS descriptor packet and at least one OIS payload packet, and to map each MLC group to an MLC descriptor packet and at least one MLC payload packet. The apparatus also comprises packet output logic configured to output the OIS descriptor packet, the OIS payload packet(s), the MLC descriptor packet, and the MLC payload packet(s) in a second packet stream.

In an aspect, an apparatus for a data interface protocol is provided. The apparatus comprises means for receiving a first packet stream comprising at least one OIS group and at least one MLC group, and means for mapping each OIS group to an OIS descriptor packet and at least one OIS payload packet. The apparatus also comprises means for mapping each MLC group to an MLC descriptor packet and at least one MLC payload packet, and means for outputting the OIS descriptor packet, the OIS payload packet(s), the MLC descriptor packet, and the MLC payload packet(s) in a second packet stream.

In an aspect, a computer program product provides a data interface protocol that comprises a machine-readable medium. The machine-readable medium comprises a first set of codes for causing a computer to receive a first packet stream comprising at least one OIS group and at least one MLC group, and a second set of codes for causing the computer to map each OIS group to an OIS descriptor packet and at least one OIS payload packet. The machine-readable medium also comprises a third set of codes for causing the computer to map each MLC group to an MLC descriptor packet and at least one MLC payload packet, and a fourth set of codes for causing the computer to output the OIS descriptor packet, the OIS payload packet(s), the MLC descriptor packet, and the MLC payload packet(s) in a second packet stream.

In an aspect, at least one processor configured to perform a method for a data interface protocol is provided. The processor(s) comprises a first module for receiving a first packet stream comprising at least one OIS group and at least one MLC group, and a second module for mapping each OIS group to an OIS descriptor packet and at least one OIS payload packet. The processor(s) also comprises a third module for mapping each MLC group to an MLC descriptor packet and at least one MLC payload packet, and a fourth module for outputting the OIS descriptor packet, the OIS payload packet(s), the MLC descriptor packet, and the MLC payload packet(s) in a second packet stream.

In an aspect, a method for a data interface protocol is provided. The method comprises receiving a first packet stream comprising an OIS descriptor packet, at least one OIS payload packet, a MLC descriptor packet, and at least one MLC payload packet. The method also comprises mapping the OIS descriptor packet and the OIS payload packet(s) to an OIS group, and mapping the MLC descriptor packet and the MLC payload packet(s) to an MLC group. The method also comprises outputting the OIS group and the MLC group in a second packet stream.

Other aspects of the interface system will become apparent after review of the hereinafter set forth Brief Description of the Drawings, Description, and the Claims.

### BRIEF DESCRIPTION OF THE DRAWINGS

The foregoing aspects described herein will become more readily apparent by reference to the following Description when taken in conjunction with the accompanying drawings wherein:

FIG. 1 shows a network that comprises an aspect of an MTI system;

FIG. 2 shows a protocol diagram for use in aspects of an MTI system;

FIG. 3 shows a transmission superframe for use in aspects of an MTI system;

FIG. 4 shows a frame of a transmission superframe that is configured for transmission in an Orthogonal Frequency Division Multiplex (OFDM) network;

FIG. 5 shows an exemplary implementation of MTI logic for use in aspects of an MTI system;

FIG. 6 shows the structure of an MTI layer packet for use in aspects of an MTI system;

FIG. 7 shows a diagram that illustrates how MAC layer OIS and MLC groups and their associated overhead information are mapped into MTI layer packets for use in aspects of an MTI system;

FIG. 8 shows an encapsulation diagram that illustrates how an MTI layer packet stream is transported using an MPEG-2 transport stream;

FIG. 9 shows a method for generating an MTI packet stream for use in aspects of an MTI system;

FIG. 10 shows a method for mapping MAC layer OIS group packets to an MTI layer OIS descriptor packet and five MTI layer OIS payload packets;

FIG. 11 shows a method for mapping MAC layer MLC group packets to an MTI layer MLC descriptor packet and two MTI layer MLC payload packets; and

FIG. 12 shows MTI logic for use in aspects of an MTI system.

### DESCRIPTION

In one or more aspects, a multiplexer to transmitter interface system, comprising methods and apparatus, is provided that operates to allow multiplexed content streams to be efficiently conveyed between an aggregation site and a large number of transmitter sites in a communication network. The system is well suited for use in wireless network environments, but may be used in any type of network environment, including but not limited to, communication networks, public networks, such as the Internet, private networks, such as virtual private networks (VPN), local area networks, wide area networks, long haul networks, or any other type of data network. Overview

A content distribution system multicasts several services for reception by receiving devices. A service is an aggregation of one or more independent data components. Each independent data component of a service is called a flow. For example, a flow can be the video component, audio component, text or signaling component of a service.

Services are classified into two types based on their coverage: Wide-area services and Local-area services. Wide-area services are generally multicast in a relatively large geographic area. A local-area service is typically multicast for reception within a subset of the wide-area service area, often a single metropolitan area.

The distribution system aggregates one or more services plus overhead information into one or more multiplexes. The multiplexes are distributed from an aggregation point (a Wide-area Operations Center (WOC) or Local-area Operations Center (LOC)) to one or more transmitter sites, where a distribution waveform is generated and broadcast over the air to receiving devices. In one or more aspects, the MTI system operates to allow multiplexed content streams to be efficiently conveyed between an aggregation site and a large number of transmitter sites.

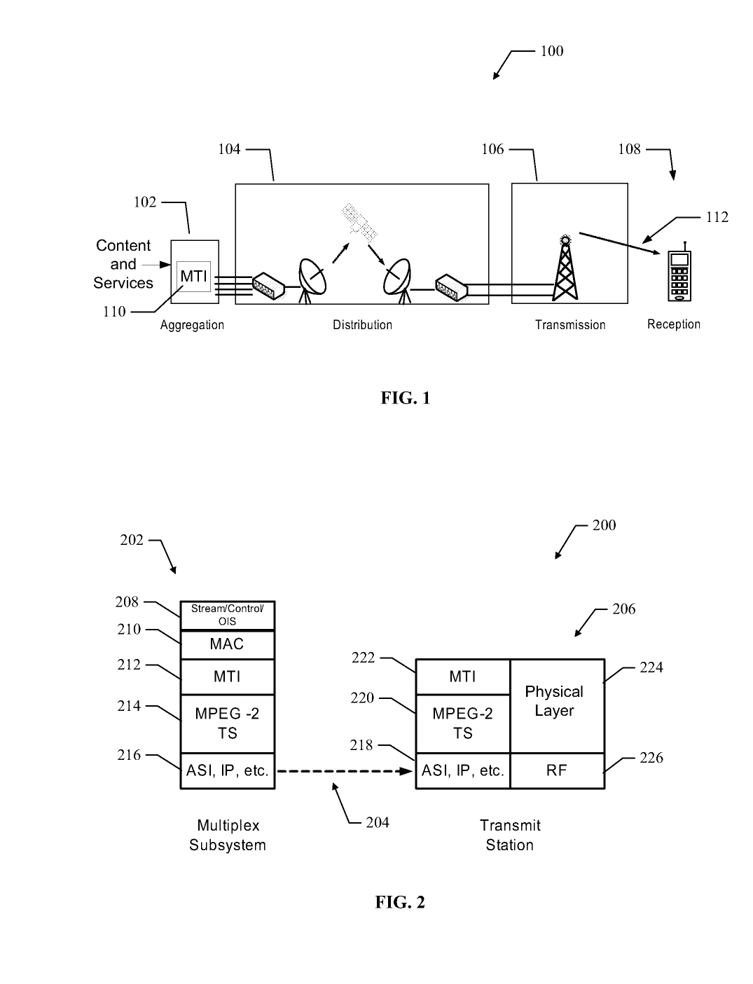

FIG. 1 shows a network 100 that comprises an aspect of a multiplexer to transmitter interface system. In an aspect, one or more Aggregation segments 102 receive audio/video and other content/services from content providers and transcodes, formats, and/or combines these sources into one or more wide-area and/or local-area multiplexes. These multiplexes are transported by a Distribution segment 104 to the appropriate local transmitter sites that are part of a Transmission segment 106. The Distribution segment 104 may use a variety of methods to transport the multiplexes from Aggregation segment 102 to the transmitter sites, such as MPEG-2 transport over satellite, or IP network transport, as long as appropriate error, latency, and other performance standards are met. Within the Transmission segment 106 there are one or more transmitter sites containing specific distribution system modulators that operate to transmit a distribution waveform 112 to receiving devices 108.

The generation of the physical layer distribution waveform (modulation, turbo encoding, overhead information generation, etc.) is performed in the Transmission segment 106. The generation of media access control (MAC) layer information is done in the Aggregation segment 102. To generate the complete distribution waveform, the transmitter must receive MAC packet data for an Overhead Information Symbol (OIS) channel and Multicast Logical Channels (MLCs), as well as additional information for the modulator indicating which physical layer mode and other transmission parameters the transmitter is to use.

In various aspects, the MTI system provides an MTI protocol layer 110 that provides a protocol to efficiently convey the MAC packet data and physical layer transmission information from the Aggregation segment 102 to the Transmission segment 106. In an aspect, the MTI protocol layer 110 operates at the Aggregation segment 102 to map MAC layer packets to MTI layer packets that are configured to have a specific structure, mapping, arrangement, size, and/or other characteristics that allow them to be efficiently inserted into an MPEG-2 transport stream. The MPEG-2 transport stream is then conveyed to the Transmission segment 106 where the MAC layer packets are recovered and used to generate the distribution waveform 112. A more detailed description of the operation of the MTI protocol layer 110 is provided below.

Therefore, aspects of the MTI system operate to efficiently map MAC layer packets at an Aggregation site for insertion in an MPEG-2 transport stream that is transmitted to a plurality of transmitter sites. It should be noted that the network 100 illustrates just one implementation and that other implementations are possible within the scope of the various aspects.

FIG. 2 shows a protocol diagram 200 for use in aspects of an MTI system. For example, the protocol diagram 200 illustrate a protocol provided by aspects of the MTI system that operate to efficiently convey content streams between the Aggregation segment 102 and the Transmission segment 106 shown in FIG. 1.

A multiplex subsystem 202 is shown that is part of the Aggregation segment 102. The multiplex subsystem 202 comprises a stream/control/OIS protocol layer 208, a MAC protocol layer 210, a MTI protocol layer 212, a MPEG-2 protocol layer 214 and a transmission protocol layer 216.

The stream/control/OIS protocol layer 208 provides content streams, control and overhead information to the MAC protocol layer 210. The MAC protocol layer 210 processes the received data and outputs MAC packets and control information to the MTI protocol layer 212. The MAC packets comprise an OIS channel and MLCs. The control information comprises information for the modulator indicating which physical layer mode and other transmission parameters. The MTI protocol 212 operates to map the MAC packets into MTI packets for input to the MPEG-2 transport stream layer 214. In an aspect, the MTI packets are configured to have a specific structure, mapping, arrangement, size, and/or other characteristics that allow them to be efficiently inserted into an MPEG-2 transport stream. In an aspect, the MTI packets are sized to fit in a private data field provided by an adaptation field found in each packet of the MPEG-2 transport stream. The MPEG-2 transport stream is input to the transmission protocol layer 216.

The transmission protocol layer 216 operates to transmit the MPEG-2 transport stream over the distribution channel 204 using ASI, IP, or other transmission technology to a plurality of transmit stations, represented by transmit station 206. Once received at the transmit station 206, the transmission protocol layer 218 operates to recover the MPEG-2 transport stream and input it to MPEG-2 protocol layer 220. At the MPEG-2 protocol layer 220, the MTI packets are extracted from the private data fields of the MPEG-2 packets and input to MTI protocol layer 222.

The MTI protocol layer 222 operates to reverse the mapping process performed at the MTI protocol layer 212 so that MAC layer packets are recovered from the MTI packets. The MAC layer packets are input to a Physical layer 224 where the content they convey is incorporated into transmission frames. The transmission frames are modulated into a distribution waveform and transmitted to devices by radio frequency (RF) logic 226.

Therefore, in an aspect, the MTI protocol layer 212 operates to map MAC layer packets comprising one or more content multiplexes into MTI packets that can be efficiently inserted into an MPEG-2 transport stream. The transport stream is then conveyed to one or more transmit stations where the MTI protocol layer 222 operates to reverse the mapping process to recover the MAC layer packets from MTI packets extracted from the received MPEG-2 transport stream. As a result, a plurality of content multiplexes are efficiently conveyed from an Aggregation segment to a plurality of transmit stations for transmission to receiving devices.

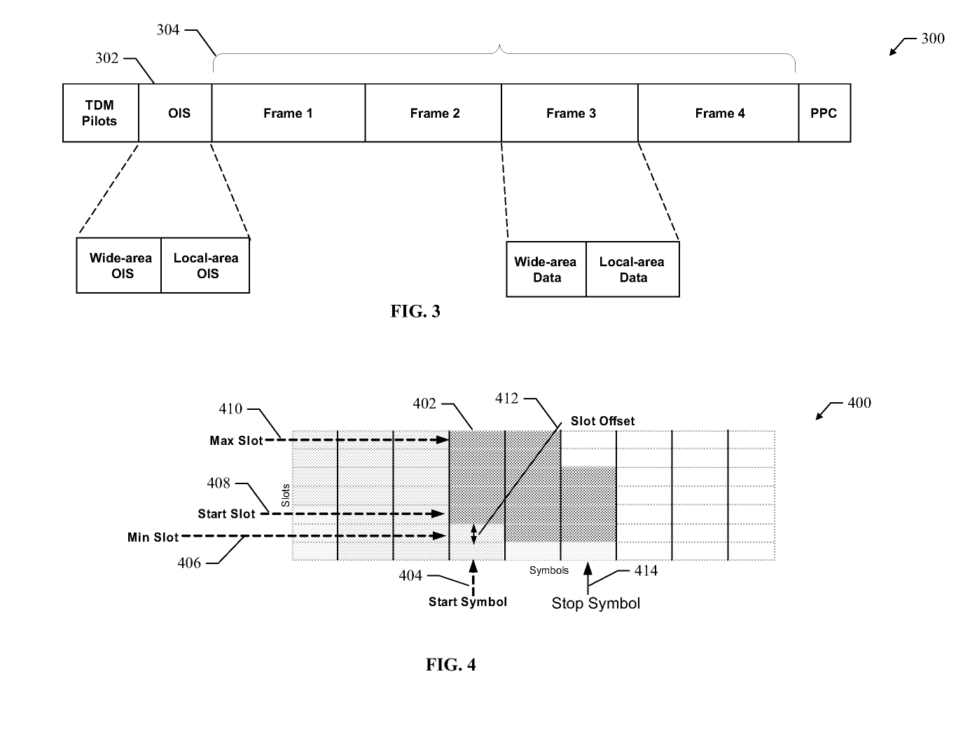

FIG. 3 shows a transmission superframe 300 for use in aspects of an MTI system. For example, the transmission superframe 300 is transmitted to devices in the distribution waveform 112 shown in FIG. 1. In an aspect, the transmission superframe 300 conveys a selected time interval of data (i.e., one second of data) and the distribution waveform 112 comprises a sequence of transmission superframes. The transmission superframe 300 comprises wide and local overhead information symbols, shown as OIS 302. The transmission superframe 300 also comprises four frames 304 that comprise wide and local data. For example, the data may comprise one or more MLCs. Thus, the transmission superframe 300 operates to convey overhead information and data to devices in communication with the transmission segment 106.

FIG. 4 shows a frame 400 of a transmission superframe that is configured for transmission in an Orthogonal Frequency Division Multiplex (OFDM) network. For example, the frame 400 may be one of the frames 304 shown in FIG. 3. In an aspect, the frame 400 is conveyed by the distribution waveform 112, shown in FIG. 1, and it will be assumed that the distribution waveform is transmitted using OFDM technology. Thus, frame 400 is configured to comprise a plurality of symbols in each of seven slots.

The frame 400 comprises a MLC 402 (shaded) that comprises data assembled in a grouping of selected symbols and slots. For example, the MLC 402 comprises data from a selected multiplex that is being conveyed by the distribution waveform 112. In an aspect, the MLC 402 is defined by a start symbol 404, a minimum slot location 406, a start slot value 408, a maximum slot value 410, a slot offset value 412, and a stop symbol 414. In an aspect, the data of the MLC 402 and its defining parameters are processed by the MTI protocol layer 212 and into to the MPEG-2 protocol layer 214 for transmission to the transmitting station 206.

FIG. 5 shows an exemplary implementation of MTI logic 500 for use in aspects of an MTI system. For example, the MTI logic 500 is suitable for use at the Aggregation segment 102 to provide the functions of the MTI protocol layer 212 illustrated in FIG. 2. The MTI logic 500 comprises packet processing logic 502, packet input logic 504, packet output logic 506, and all coupled to a data bus 508.

The packet input logic 504 comprises hardware, software, and/or any combination thereof. The packet input logic 504 operates to receive packets from a MAC protocol layer, for example, the MAC protocol layer 210 shown in FIG. 2. The packet input logic 504 passes received packets to the packet processing logic 502 for processing in accordance with the MTI protocol layer 212.

The packet processing logic 502 comprises at least one of a CPU, processor, gate array, hardware logic, memory elements, virtual machine, software, and/or any combination of hardware and software. Thus, the packet processing logic 502 generally comprises logic to execute machine-readable instructions to provide packet processing and to control one or more other functional elements of the MTI logic 500 using the data bus 508.

In an aspect, the packet processing logic 502 operates to process packets received from a MAC layer protocol and produce MTI layer packets that are to be inserted into an MPEG-2 transport stream. The packet processing logic 502 operates map the MAC packets into MTI packets that are configured to have a specific structure, mapping, arrangement, size, and/or other characteristics that allow them to be efficiently inserted into an MPEG-2 transport stream. A more detailed description of the operation of the packet processing logic 502 is provided in another section of this document.

The packet output logic 506 comprises hardware, software, and/or any combination thereof. The packet output logic 506 operates to output generated MTI layer packets generated by the packet processing logic 502 to an MPEG-2 protocol layer. For example, the packet output logic 506 outputs generated MTI layer packets to the MPEG-2 protocol layer 214 shown in FIG. 2.

Therefore, aspects of the MTI system operate to perform one or more of the following functions.
1. Receive packets from a MAC protocol layer.
2. Process the received MAC packets to produce MTI layer packets that are configured to have a specific structure, mapping, arrangement, size, and/or other characteristics that allow them to be efficiently inserted into an MPEG-2 transport stream.
3. Output the MTI layer packets to an MPEG-2 protocol layer.

In an aspect, the MTI system comprises one or more program instructions (“instructions”) or sets of codes (“codes”) stored on a machine-readable medium, which when executed by at least one processor, for instance, a processor at the packet processing logic 502, provides the functions described herein. For example, the codes may be loaded into the packet processing logic 502 from a machine-readable medium, such as a floppy disk, CDROM, memory card, FLASH memory device, RAM, ROM, or any other type of memory device or machine-readable medium that interfaces to the packet processing logic 502. In another aspect, the codes may be downloaded into the packet processing logic 502 from an external device or network resource. The codes, when executed, provide aspects of an MTI system as described herein.

Therefore, the MTI system operates to process MAC layer packets to produce MTI layer packets that are specifically formatted for insertion into an MPEG-2 transport stream. It should be noted that the MTI logic 500 is just one implementation and that other implementations are possible within the scope of the aspects.

### MTI Packet Formats

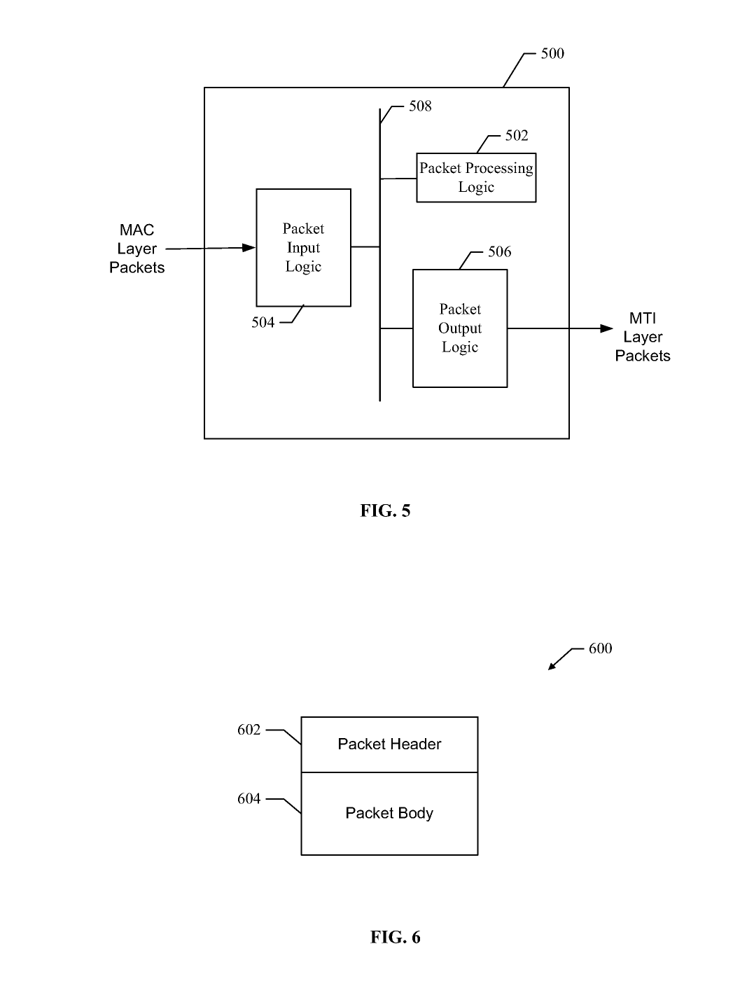

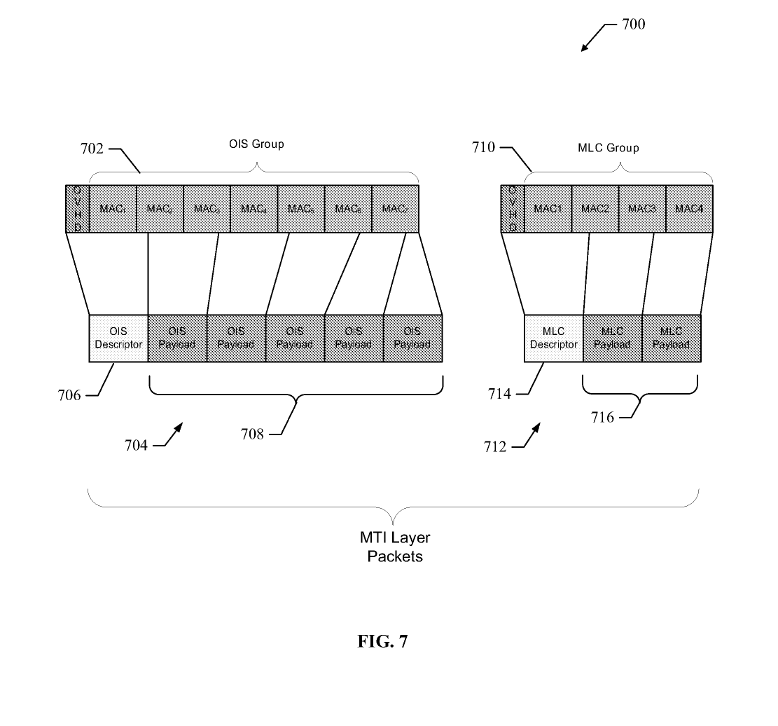

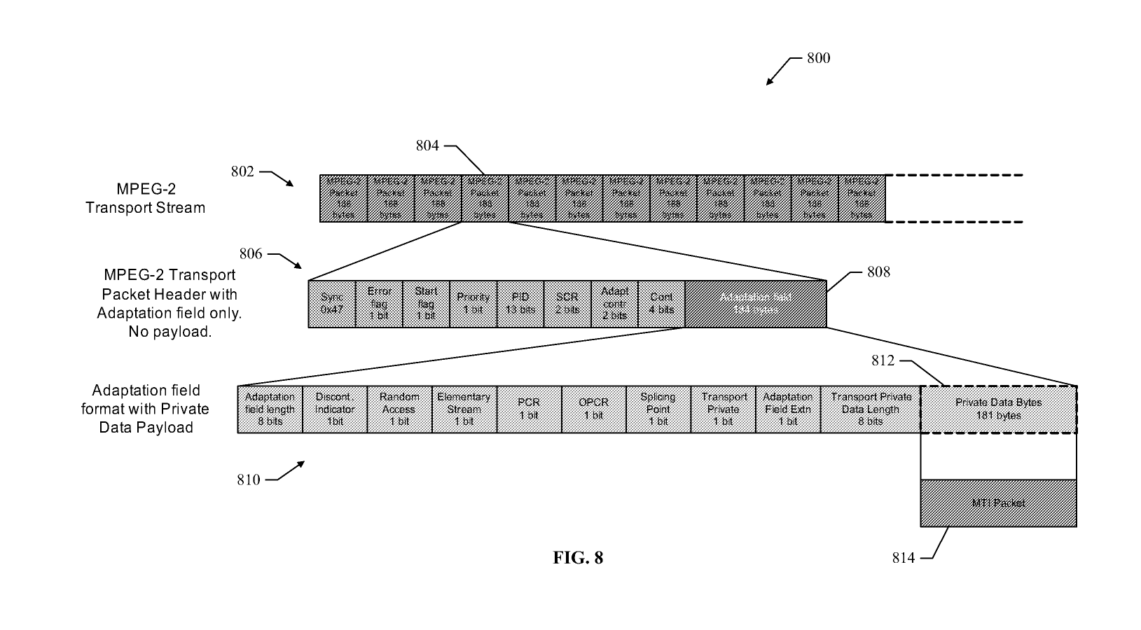

FIG. 6 shows the structure of an MTI layer packet 600 for use in aspects of an MTI system. In an aspect, the packet processing logic 502 operates to receive MAC layer packets and generate MTI layer packets. The MTI layer packet 600 comprises a packet header 602 and a packet body 604. In an aspect, the MTI system operates to configure all MTI packets to have a size of 181 bytes. This allows the MTI packets to be efficiently inserted into an MPEG-2 transport stream. It should be noted that the MTI packet header 602 format is the same for all MTI packets. The following is a description of four types of MTI packets that may be generated by the packet processing logic 502.
1. OIS Descriptor Packet
2. OIS Payload Packet
3. MLC Descriptor Packet
4. MLC Payload Packet

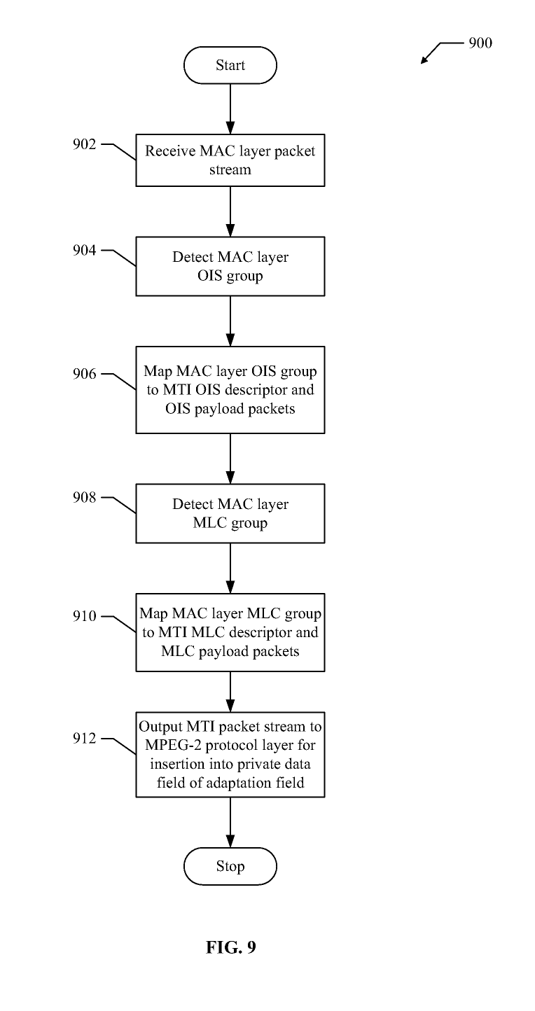

FIG. 7 shows a diagram 700 that illustrates how MAC layer OIS and MLC groups and their associated overhead information are mapped into MTI layer packets for use in aspects of an MTI system. For example, the packet processing logic 502 operates to receive MAC layer packets representing OIS and MLC groups and map these groups into MTI layer packets. In an aspect, a sequence of seven MAC layer packets that describe OIS information for a single wide-area or local area multiplex constitutes an OIS group, and a sequence of four MAC layer packets that describe MLC information for a single MLC constitutes an MLC group.

In an aspect, MAC layer OIS group 702 information is mapped to a sequence of six MTI packets 704 by the packet processing logic 502. The six MTI packets 704 comprise a single OIS Descriptor 706 packet followed by five OIS Payload packets 708. The OIS Descriptor packet 706 contains the MAC layer OIS overhead information (OVHD) plus the OIS MAC packet data for the first OIS MAC packet (MAC₁) and a portion of the second OIS MAC packet (MAC₂). The remaining OIS group 702 MAC packets are mapped to the next five successive MTI layer OIS Payload Packets 708.

In an aspect, the MAC layer MLC group 710 information is mapped to a sequence of three MTI layer packets 712. The three MTI layer packets 712 comprise a single MLC Descriptor packet 714 followed by two MLC Payload packets 716. The MLC Descriptor packet 714 contains the MAC layer MLC overhead information (OVHD) plus the MLC MAC packet data for the first MLC MAC packet (MAC₁) and a portion of the second MLC MAC packet (MAC₂). The remaining MLC group 710 MAC packet data is mapped to the next two successive MTI layer MLC Payload Packets 716.

Therefore, in an aspect of an MTI system, a sequence of MTI layer packets to be transmitted from a multiplex subsystem to transmit stations for each superframe of a single wide-area or local-area multiplex comprises the following.
1. An OIS Descriptor packet 706 followed by five OIS Payload packets 708, comprising the wide and/or local OIS information.
2. Multiple instances of the sequence of: a single MLC Descriptor packet 714 followed by two MLC Payload packets 716. The number of instances of this sequence varies with the number of MAC packets produced for that particular superframe.

Additional multiplexers will produce a similar sequence of MTI layer packets for each additional wide-area or local-area multiplex.

### MTI Packet Header

Referring again to FIG. 6, The MTI packet 600 comprises a packet header 602 and a packet body 604. The packet header 602 comprises selected fields as illustrated in Table 1.

TABLE 1

| Field | Length (bytes) |
|---|---|
| MTI Revision | 1 |
| Minimum MTI Revision | 1 |
| Packet ID | 1 |
| Superframe Sequence No | 4 |
| Packet Counter | 2 |
| Reserved | 4 |

The following is a description of the MTI Packet Header fields illustrated in Table 1.
1. MTI revision—This field indicates the revision number of the MTI protocol of the current MTI packet.
2. Minimum MTI revision—This field indicates the lowest MTI protocol revision number that the transmit station must implement to correctly interpret the current MTI packet.
3. Packet ID—This field indicates the type of the MTI packet. Table 2 provides a list of the types of MTI packets and their associated Packet IDs (PID).
4. Superframe Sequence Number—The Superframe Sequence Number is incremented by one (modulo 232) for each new superframe. This field indicates the superframe to which a packet belongs. All MTI packets that correspond to the same superframe will have the same superframe sequence number.
5. Packet Counter—The Packet Counter is incremented by one (modulo 216) for each successive MTI packet transmitted. It can be used to detect the loss, re-ordering, or duplication of MTI packets over the communications link.
6. Reserved—These bytes are reserved.

TABLE 2

| Packet ID | Packet Type |
|---|---|
| 1 | OIS Descriptor Packet |
| 2 | OIS Payload Packet |
| 3 | MLC Descriptor Packet |
| 4 | MLC Payload Packet |
| 5-255 | Reserved |

### OIS Descriptor Packet

The OIS Descriptor packet comprises the following information.
1. MTI Packet Header
2. OIS Overhead Information
3. OIS Data

The OIS overhead information comprises the slot allocation information (as illustrated in FIG. 4) and other physical layer information that the transmitter uses to produce the OIS portion of the distribution waveform.

The OIS Descriptor packet in a Wide-Area multiplex provides the slot allocation address information for the Wide-Area OIS, and the OIS Descriptor packet in a Local-Area multiplex provides slot allocation address information for the Local-Area OIS. The OIS Descriptor packet comprises selected fields as illustrated in Table 3.

TABLE 3

| Field | Length (bytes) |
|---|---|
| MTI packet Header | Refer to Table 1 |
| OFDM Start Symbol | 2 |
| OFDM Stop Symbol | 2 |
| Min Slot | 1 |
| Max Slot | 1 |
| Slot Offset | 1 |
| MLC Mode | 1 |
| Reserved | 3 |
| OIS Data | 157 |

The following is a description of the fields in the OIS descriptor packet.
1. OFDM Start Symbol—This field specifies the OFDM Start Symbol of the OIS.
2. OFDM Stop Symbol—This field specifies the OFDM Stop Symbol of the OIS.
3. Min Slot—This field specifies the minimum slot of the OIS.
4. Max Slot—This field specifies the maximum slot of the OIS.
5. Slot Offset—This field specifies the Slot Offset of the OIS.
6. MLC Mode—This field specifies the MLC transmit mode of the OIS.
7. Reserved—This field is typically ignored by the Transmit Station. It is present so that the common fields in the OIS and MLC Descriptor packets are at the same byte offset in the MPEG-2 Transport Packet.
8. OIS Data—The field contains the first OIS MAC packet (MAC₁) of the MAC layer OIS group 702, and the first 35 bytes of the second OIS MAC packet (MAC₂) of the MAC layer OIS group 702.

In an aspect, the MTI packet stream comprises an OIS Descriptor Packet as the first packet for a superframe. It should be noted that allowable values for OFDM start and stop symbols, min and max slot values, and MLC mode fields may be suitably specified.

### OIS Payload Packet

The OIS Payload packet comprises selected fields as illustrated in Table 4. The OIS Payload packet carries MAC packet data for the Wide-Area OIS and the Local-Area OIS. There are five (5) MTI layer OIS Payload packets for the Wide-Area OIS and five (5) MTI layer OIS Payload packets for the Local-Area OIS. The OIS Data/Padding field shown in Table 4 is a field that contains OIS MAC packet data.

TABLE 4

| Field | Length (bytes) |
|---|---|
| MTI packet Header | Refer to Table 1 |
| OIS Data/Padding | 168 |

The following are additional aspects of MTI layer packets generated by the MTI system.
1. The five (5) MTI packets immediately after an OIS Descriptor Packet are the associated OIS Payload packets.
2. The first OIS Payload packet contains the last 87 bytes of the second OIS group MAC packet and the first 81 bytes of the third OIS group MAC packet.
3. The second MTI OIS Payload packet contains the last 41 bytes of the third OIS group MAC packet, the fourth OIS group MAC packet and the first 5 bytes of the fifth OIS group MAC packet.
4. The third MTI OIS Payload packet contains the last 117 bytes of the fifth OIS group MAC packet, and the first 51 bytes of the sixth OIS group MAC packet.
5. The fourth MTI OIS Payload packet contains the last 71 bytes of the sixth OIS group MAC packet and first 97 bytes of the seventh OIS group MAC packet.
6. The fifth MTI OIS Data Payload packet contains the last 25 bytes of the seventh OIS group MAC packet and 143 bytes of padding.

### MLC Descriptor Packet

The MLC Descriptor packet contains the overhead information for an MLC group. The MLC Descriptor packet comprises selected fields as illustrated in Table 5.

The MLC Descriptor packet comprises the following:
1. MTI Packet Header
2. MLC Overhead Information
3. MLC Data

The MLC overhead information comprises slot allocation information and other physical layer information that a transmitter uses to transmit MLC data in a distribution waveform.

The MLC Descriptor packet is the first MTI packet in the sequence of MTI packets describing a MLC. A single MLC Descriptor packet is sent for each sequence of two MLC Payload Packets.

TABLE 5

| Field | Length (bytes) |
|---|---|
| MTI packet Header | Refer to Table 1 |
| OFDM Start Symbol | 2 |
| OFDM Stop Symbol | 2 |
| Min Slot | 1 |
| Max Slot | 1 |
| Slot Offset | 1 |
| MLC Mode | 1 |
| MLC Group Flags | 1 |
| Reserved | 2 |
| MAC Data | 157 |

The following is a description of the fields of the MLC Descriptor packet.
1. OFDM Start Symbol—This field indicates the OFDM Start Symbol for the MLC group associated with MLC Descriptor packet. The MLC Descriptors are ordered in the MPEG-2 Transport Stream based on this field. The order does not matter for MLC Descriptors that have the same OFDM Start Symbol.
2. OFDM Stop Symbol—This field indicates the OFDM Stop Symbol for the MLC group associated with the MLC Descriptor packet. The OFDM Start Symbol is less than the OFDM Stop Symbol.
3. Min slot—This field represents the minimum slot value for the MLC group associated with the MLC Descriptor packet.
4. Max slot—This field represents the maximum slot value for the MLC group associated with the MLC Descriptor packet.
5. Slot Offset—This field represents the slot offset value for the MLC group associated with the MLC Descriptor packet. The Slot Offset is less than the value of the (Max Slot-Min Slot)
6. MLC Mode—This field represent the MLC transmit mode for the MLC group associated with the MLC Descriptor packet.
7. MLC Group Flags—This field indicates the presence of Enhanced MAC packets that need to be transmitted for the MLC. The format of the MLC Group flags is as shown in Table 6.

TABLE 6

| | | | | | | | | Bit |
|---|---|---|---|---|---|---|---|---|
| | | | | | | | | Po- |
| 7 | 6 | 5 | 4 | 3 | 2 | 1 | 0 | sition |
| Reserved | Reserved | Reserved | Reserved | B3 | B2 | B1 | B0 | |

With regards to Table 6, bit positions B0-B3 correspond to the 4 MAC packets in a MLC group as follows: BO corresponds to the first MLC MAC packet in the MLC group, B1 the second, B2 the third, and B3 corresponds to the last MLC MAC packet in the MLC Group (see FIG. 4).

A zero (0) in any of these bits indicates that the MAC packet associated with the bit in the MLC Group Flags field is a base layer MAC packet, while a one (1) indicates that the packet is an Enhancement Layer MAC packet. The bits B4-B7 are reserved and are typically set to zero (0). The MTI packets containing enhancement layer data precede MTI packets containing their corresponding base layer data.

Referring again to Table 5, the remaining fields to be described are as follows.
8. Reserved—These bytes are unused.
9. MAC Data—This field contains the first MAC packet (MLC group, MAC₁) and the first 35 bytes of the second MAC packet (MLC group, MAC₂).

It should be noted that allowable values for OFDM start and stop symbols, min and max slot values, and MLC mode fields may be suitably specified.

The following are additional aspects of MTI layer packets generated by the MTI system.
1. MLC Groups are transmitted in ascending order based on the value of the OFDM Start Symbol field in the MLC Descriptor packet.
2. An MLC Group containing Enhancement layer data is transmitted immediately preceding the MLC group containing the corresponding Base layer MLC Group.
3. The MLC group flag field is set according to Table 6.
4. The OFDM Stop Symbol is set to have a value equal to or greater than the OFDM Start Symbol.
5. The value of the Slot Offset in the MLC Descriptor will be less than Max Slot-Min Slot.
6. The MLC group flags are set to (0×00) in the MLC Descriptor for a Base Layer MLC group.

### MLC Payload Packet

The MTI layer MLC Payload packet contains the MAC packet data from the MLC group. There are two (2) MTI layer MLC Payload packets per MAC layer MLC group. The MLC Payload packet comprises selected fields as illustrated in Table 7.

TABLE 7

| Field | Length (bytes) |
|---|---|
| MTI Packet Header | Refer to Table 1 |
| MAC Data/padding | 168 |

The following is a description of the MAC Data/padding field of an MTI layer MLC Payload packet.
1. MAC Data—This field in both the first and second MTI layer MLC Payload packets contain the MAC Data from the second, third and fourth MAC packets of the MLC group.

The following are additional aspects of MTI layer packets generated by the MTI system.
1. The two (2) packets immediately after the MLC Descriptor packet are associated MLC Payload packets.
2. The first MLC Payload packet will contain the last 87 bytes of the second MAC packet of the MLC group and the first 81 bytes of the third MAC packet of the MLC group.
3. The second MLC Payload packet will contain the last 41 bytes of the third MAC packet of the MLC group and the fourth MAC packet of the MLC group.

### MPEG-2 Transport Stream Encapsulation

FIG. 8 shows an encapsulation diagram 800 that illustrates how an MTI layer packet stream is transported using an MPEG-2 transport stream. An MPEG-2 transport stream 802 comprises a stream of MPEG-2 packets (for example, packet 804), where each packet comprises a total of 188 bytes of information.

The MPEG-2 packet 804 is illustrated in detail by the packet 806. The packet 806 comprises a header portion and an adaptation field 808. The adaptation field 808 is illustrated in detail by adaptation field 810. The adaptation field 810 comprises a private data portion 812 that has a size of 181 bytes. In accordance with aspects of the MTI system, the privation data portion 812 is used to carry MTI layer packets, as shown at 814, which also are configured to have a size of 181 bytes. MPEG-2 Transport Parameters

In an aspect, MTI packets are carried in the Private Data portion of the Adaptation header of the MPEG-2 Transport Packet. Each stream of MTI packets comprising a unique wide area or local area multiplex is assigned to its own MPEG-2 transport stream, with a unique PID, as described below.

### MPEG-2 Transport Packet Header

The following are the MPEG-2 Transport Packet Header fields and their descriptions.
1. Sync byte (8-bits)—The sync byte identifies the start of an MPEG-2 Transport Packet. The value of this field is ‘0100 0111’ (0×47).
2. Transport Error (1-bit)—The transport error indicator is a 1-bit flag. This bit will be set to 1 if the Reed Solomon Erasure correction fails to correct errors in the MPEG-2 Transport Packet.
3. Payload Unit Start Indicator (1-bit)—The Payload Unit Start indicator is used for Transport Packets that carry Packetized Elementary Stream Packets and Program Specific Information Data. This field is not used and is set to 0.
4. Transport Priority (1-bit)—The transport priority indicates that the associated Transport Packet is of greater priority than other packets having the same PID which do not have the bit set to 1. This field is not used and is set to 0.
5. PID (13-bits)—The PID is a 13-bit field indicating the type of data stored in the packet payload. Each of the Multiplexes (Wide-area and Local-area) is assigned a PID that is unique in the distribution system. A valid range of PID values for use in the MTI system is 0×0020 to 0×1FF6. Each Transmit Station is provisioned with the PIDs for the Wide-area and Local-area Transport Stream it is assigned to transmit.
6. Transport Scrambling Control (2-bits)—This field indicates the scrambling mode of the Transport Stream packet payload. Transport Stream scrambling is disabled and the value of this field is set to 00.
7. Adaptation Field Control (2-bits)—This field indicates whether the Transport Stream packet header is followed by an adaptation field and/or payload. This field is set to 10 to indicate that there is only an adaptation field and no payload.
8. Continuity Counter (4-bits)—The Continuity Counter is used to detect the discontinuities in the MPEG-2 Transport Stream although the Continuity Counter is not used if the adaptation field and no payload is present in the Transport Packet. This field is set to 0000.
9. Adaptation Field (184 bytes)—The adaptation field is made up of the following fields.
   a. Adaptation Field Length (8-bits)—This field specifies the number of bytes in the adaptation field immediately following the adaptation field length. The adaptation field length is set to 183.
   b. Discontinuity Indicator (1-bit)—This field is used to indicate that the discontinuities in the transport stream in either the system time base or the continuity counter. The discontinuity indicator is not used and is set to 0.
c. Random Access Indicator (1-bit)—This field is used to indicate that the current and subsequent transport packets with the same PID contain some information to aid random access. This field is used only when the MPEG-2 transport packet is carrying video or audio data. The Random Access Indicator is not used and is set to 0.
   d. Elementary Stream Priority Indicator (1-bit)—The Elementary Stream priority indicator indicates priority among packets with the same PID, the priority of the elementary stream data carried within the payload of this Transport Stream Packet. This field is not used and is set to 0.
   e. PCR Flag (1-bit)—This field is used to indicate the presence of a Program Clock Reference in the adaptation field. This field is not used and is set to 0.
   f. OPCR Flag (1-bit)—This field is used to indicate the presence of the original program clock reference field in the adaptation field. This field is not used and is set to 0.
   g. Splicing Point Flag (1-bit)—This field is used to indicate the presence of a splice countdown field in the adaptation field specifying the occurrence of a splicing point. This field is not used and is set to 0.
   h. Transport Private Data Flag (1-bit)—This field indicates that the adaptation field contains private data. This field is set to 1. The MTI layer packets and associated signaling are carried as private data in the adaptation field.
   i. Adaptation Field Extension Flag (1-bit)—This field indicates the presence of an adaptation field extension. This field is not used and is set to 0.
   j. Transport Private Data Length (8-bits)—This field specifies the number of private data bytes immediately following the Transport Private Data Length field. This field is set to 181.
   k. Private Data (181 Bytes)—The Private Data portion of the adaptation field carries the MTI layer packets. All MTI packets are 181 bytes in length, and therefore fit into this field with no additional padding required.

FIG. 9 shows a method 900 for generating an MTI packet stream for use in aspects of an MTI system. For clarity, the method 900 is described herein with reference to the MTI logic 500 shown in FIG. 5. For example, in an aspect, the packet processing logic 502 executes one or more sets of codes to control the MTI logic 500 to perform the functions described below.

At block 902, a MAC layer packet stream is received. For example, the MAC layer packet stream is received from MAC layer protocol 210 executing at the multiplex subsystem 202. In an aspect, the MAC layer packet stream is received by packet input logic 504.

At block 904, a MAC layer OIS packet group is detected in the received MAC layer packet stream. For example, the MAC layer OIS packet group is formatted as the OIS packet group 702 shown in FIG. 7. In an aspect, the packet processing logic 502 operates to detect the MAC layer OIS packet group.

At block 906, the MAC layer OIS packet group is mapped to a MTI OIS descriptor packet and MTI OIS payload packets. For example, the MAC layer OIS packet group 702 is mapped to the MTI OIS descriptor packet 706 and the MTI OIS payload packets 708. In an aspect, the packet processing logic 502 operates to perform the mapping function. As a result, the MTI OIS descriptor packet and the MTI OIS payload packets are generated, as illustrated in FIG. 7, and each packet has a size of 181 bytes.

At block 908, a MAC layer MLC packet group is detected in the received MAC layer packet stream. For example, the MAC layer MLC packet group is formatted as the MLC packet group 710 shown in FIG. 7. In an aspect, the packet processing logic 502 operates to detect the MAC layer MLC packet group.

At block 910, the MAC layer MLC packet group is mapped to a MTI MLC descriptor packet and MTI MLC payload packets. For example, the MAC layer MLC packet group 710 is mapped to the MTI MLC descriptor packet 714 and the MTI MLC payload packets 716. In an aspect, the packet processing logic 502 operates to perform the mapping function. As a result, the MTI MLC descriptor packet and the MTI MLC payload packets are generated, as illustrated in FIG. 7, and each packet has a size of 181 bytes.

At block 912, an MTI packet stream is output to an MPEG-2 protocol layer. For example, the MTI protocol layer 212 outputs the MTI packet stream to the MPEG-2 protocol layer 214 for insertion into a MPEG-2 transport stream. For example, each MTI packet is inserted into a private data field that is located in an adaptation field of an MPEG-2 transport packet. Since the packets in the MTI packet stream have a size of 181 bytes each, the MTI packets can be efficiently inserted into the private data field without additional padding.

Thus, the method 900 operates to map MAC layer packets to MTI layer packets that can be efficiently inserted into an MPEG-2 transport stream. It should be noted that the method 900 represents just one implementation and that other implementations are possible within the scope of the aspects.

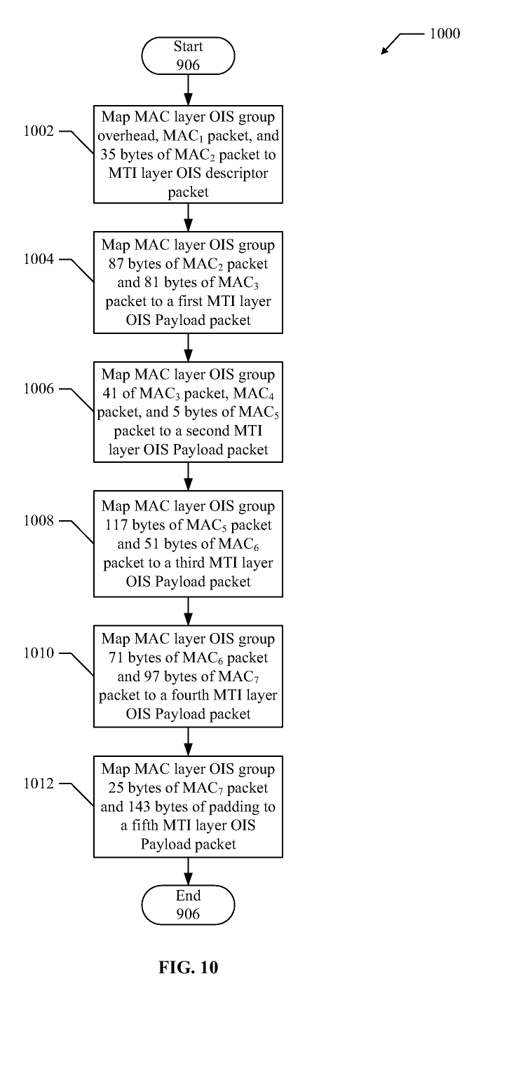

FIG. 10 shows a method 1000 for mapping MAC layer OIS group packets to an MTI layer OIS descriptor packet and five MTI layer OIS payload packets. For example, the method 1000 is suitable for use at block 906 of the method 900 shown in FIG. 9. For clarity, the method 1000 is described herein with reference to the MTI logic 500 shown in FIG. 5. For example, in an aspect, the packet processing logic 502 executes one or more sets of codes to control the MTI logic 500 to perform the functions described below.

At block 1002, a MTI layer OIS descriptor packet is generated. In an aspect, a MAC layer OIS group overhead packet, MAC₁ packet, and 35 bytes of a MAC₂ packet are mapped to the MTI layer OIS descriptor packet. For example, the MAC layer OIS group packets are mapped to the MTI layer OIS descriptor packet as illustrated in FIG. 7.

At block 1004, a first MTI layer OIS payload packet is generated. In an aspect, 87 bytes of a MAC layer OIS group MAC₂ packet, and 81 bytes of a MAC₃ packet are mapped to the first MTI layer OIS payload packet. For example, the MAC layer OIS group packets are mapped to the first MTI layer payload packet as illustrated in FIG. 7.

At block 1006, a second MTI layer OIS payload packet is generated. In an aspect, 41 bytes of a MAC layer OIS group MAC₃ packet, a MAC₄ packet, and 5 bytes of a MAC₅ packet are mapped to the second MTI layer OIS payload packet. For example, the MAC layer OIS group packets are mapped to the second MTI layer payload packet as illustrated in FIG. 7.

At block 1008, a third MTI layer OIS payload packet is generated. In an aspect, 117 bytes of a MAC layer OIS group MAC₅ packet and 51 bytes of a MAC₆ packet are mapped to the third MTI layer OIS payload packet. For example, the MAC layer OIS group packets are mapped to the third MTI layer payload packet as illustrated in FIG. 7.

At block 1010, a fourth MTI layer OIS payload packet is generated. In an aspect, 71 bytes of a MAC layer OIS group MAC₆ packet and 97 bytes of a MAC₇ packet are mapped to the fourth MTI layer OIS payload packet. For example, the MAC layer OIS group packets are mapped to the fourth MTI layer payload packet as illustrated in FIG. 7.

At block 1012, a fifth MTI layer OIS payload packet is generated. In an aspect, 23 bytes of a MAC layer OIS group MAC₇ packet and 143 bytes of padding are mapped to the fifth MTI layer OIS payload packet. For example, the MAC layer OIS group packets are mapped to the fifth MTI layer payload packet as illustrated in FIG. 7. The method then proceeds to block 908 of the method 900 shown in FIG. 9.

Thus, the method 1000 operates to map MAC OIS group packets to an MTI OIS descriptor packet and five MTI OIS payload packets. It should be noted that the method 1000 represents just one implementation and that other implementations are possible within the scope of the aspects.

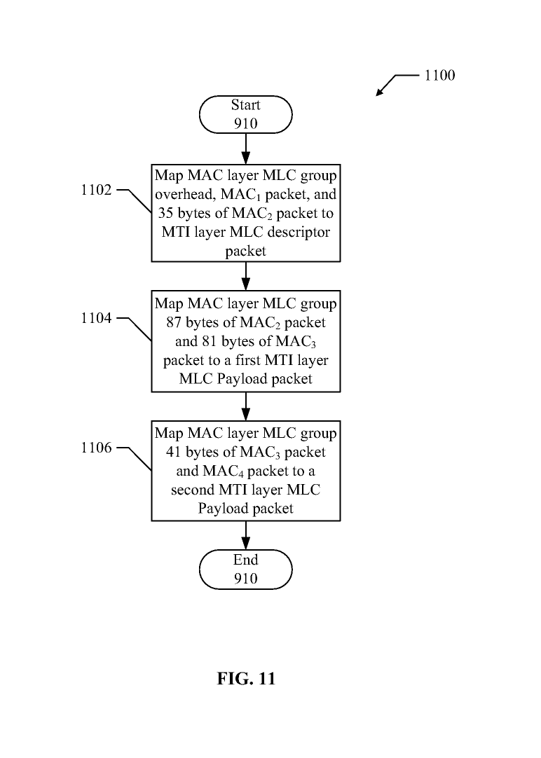

FIG. 11 shows a method 1100 for mapping MAC layer MLC group packets to an MTI layer MLC descriptor packet and two MTI layer MLC payload packets. For example, the method 1100 is suitable for use at block 910 of the method 900 shown in FIG. 9. For clarity, the method 1100 is described herein with reference to the MTI logic 500 shown in FIG. 5. For example, in an aspect, the packet processing logic 502 executes one or more sets of codes to control the MTI logic 500 to perform the functions described below.

At block 1102, a MTI layer MLC descriptor packet is generated. In an aspect, a MAC layer MLC group overhead packet, MAC₁ packet, and 35 bytes of a MAC₂ packet are mapped to the MTI layer MLC descriptor packet. For example, the MAC layer MLC group packets are mapped to the MTI layer MLC descriptor packet as illustrated in FIG. 7.

At block 1104, a first MTI layer MLC payload packet is generated. In an aspect, 87 bytes of a MAC layer MLC group MAC₂ packet, and 81 bytes of a MAC₃ packet are mapped to the first MTI layer MLC payload packet. For example, the MAC layer MLC group packets are mapped to the first MTI layer payload packet as illustrated in FIG. 7.

At block 1006, a second MTI layer MLC payload packet is generated. In an aspect, 41 bytes of a MAC layer MLC group MAC₃ packet and a MAC₄ packet are mapped to the second MTI layer MLC payload packet. For example, the MAC layer MLC group packets are mapped to the second MTI layer payload packet as illustrated in FIG. 7. The method then proceeds to block 912 of the method 900 shown in FIG. 9.

Thus, the method 1100 operates to map MAC MLC group packets to an MTI MLC descriptor packet and two MTI MLC payload packets. It should be noted that the method 1100 represents just one implementation and that other implementations are possible within the scope of the aspects.

### Transmit Station

Referring again to FIG. 2, the transmit station 206 comprises MTI layer 222. The MTI layer 222 operates to receive MTI layer packets that have been transported in an MPEG-2 transport stream. For example, the MTI layer packets are extracted from the adaptation fields of the MPEG-2 transport stream by the MPEG-2 layer 220. The MTI layer 222 operates to reverse the mapping process performed by the MTI layer 212 at the multiplex subsystem 202 to produce MAC layer packets that are input to the physical layer 224.

In an aspect, the functions of the MTI layer 222 are provided by logic similar to the MTI logic 500 shown in FIG. 5. For example, the functions of the MTI layer 222 can be performed by the MTI logic 500 configured to reverse the mapping processes illustrated in FIGS. 9, 10 and 11. Thus, it is not necessary that additional figures be provided since one with skill in the art could easily modify the MTI logic 500 to perform the functions of the MTI layer 222.

Therefore, in an aspect, the MTI layer 222 operates to perform one or more of the following functions.
1. Receive MTI layer packets from MPEG-2 layer 200.
2. Reverse the mapping processes performed by the MTI layer 212 to produce MAC layer packets. For example, the mapping processes illustrated in FIGS. 9, 10 and 11 are reversed to produce the MAC layer packets.
3. Output the MAC layer packets to the physical layer 224.

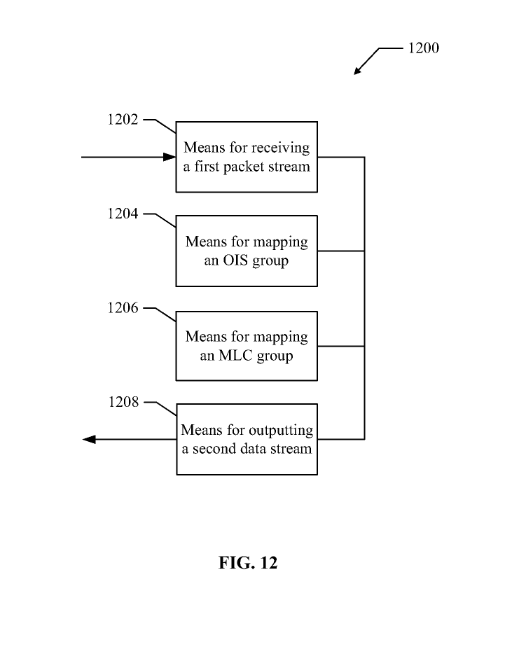

FIG. 12 shows MTI logic 1200 for use in aspects of an MTI system. For example, the MTI logic 1200 is suitable for use as the MTI logic 500 shown in FIG. 5. In an aspect, the MTI logic 1200 is implemented by at least one processor comprising one or more modules configured to provide aspects of a coding system as described herein. For example, each module comprises hardware, software, or any combination thereof.

The MTI logic 1200 comprises a first module comprising means (1202) for receiving a first packet stream, which in an aspect comprises the packet input logic 504. The MTI logic 1200 also comprises a second module comprising means (1204) for mapping an OIS group to an OIS descriptor packet and at least one OIS payload packet, which in an aspect comprises the packet processing logic 502. The MTI logic 1200 also comprises a third module comprising means (1206) for mapping an MLC group to an MLC descriptor packet and at least one MLC payload packet, which in an aspect comprises the packet processing logic 502. The MTI logic 1200 also comprises a fourth module comprising means (1208) for outputting the OIS descriptor packet, the OIS payload packet(s), the MLC descriptor packet, and the MLC payload packet(s) in a second packet stream, which in an aspect comprises the packet output logic 506.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed aspects is provided to enable any person skilled in the art to make or use the present invention. Various modifications to these aspects may be readily apparent to those skilled in the art, and the generic principles defined herein may be applied to other aspects, e.g., in an instant messaging service or any general wireless data communication applications, without departing from the spirit or scope of the invention. Thus, the present invention is not intended to be limited to the aspects shown herein but is to be accorded the widest scope consistent with the principles and novel features disclosed herein. The word “exemplary” is used exclusively herein to mean “serving as an example, instance, or illustration.” Any aspect described herein as “exemplary” is not necessarily to be construed as preferred or advantageous over other aspects.

Accordingly, while aspects of a MTI system have been illustrated and described herein, it will be appreciated that various changes can be made to the aspects without departing from their spirit or essential characteristics. Therefore, the disclosures and descriptions herein are intended to be illustrative, but not limiting, of the scope of the invention, which is set forth in the following claims.

What is claimed is:

1. A method for providing a data interface protocol, the method comprising:
receiving a first packet stream comprising at least one overhead information symbol (OIS) group and at least one multicast logical channel (MLC) group;
mapping each OIS group to an OIS descriptor packet and at least one OIS payload packet;
mapping each MLC group to an MLC descriptor packet and at least one MLC payload packet; and
outputting the OIS descriptor packet, the at least one OIS payload packet, the MLC descriptor packet, and the at least one MLC payload packet in a second packet stream.

2. The method of claim 1, wherein said receiving comprises receiving a MAC layer packet stream that comprises the at least one OIS group and the at least one MLC group.

3. The method of claim 1, wherein said mapping each OIS group comprises mapping the each OIS group to the OIS descriptor packet and five OIS payload packets.

4. The method of claim 3, wherein said mapping each OIS group comprises mapping the each OIS group to the OIS descriptor packet and the five OIS payload packets, wherein the OIS descriptor packets and the five OIS payload packets each comprise 181 bytes.

5. The method of claim 1, wherein said mapping each MLC group comprises mapping the each MLC group to an MLC descriptor packet and two MLC payload packets.

6. The method of claim 5, wherein said mapping each MLC group comprises mapping the each MLC group to the MLC descriptor packet and the two MLC payload packets, wherein the MLC descriptor packet and the two MLC payload packets each comprise 181 bytes.

7. The method of claim 1, wherein said outputting comprises outputting the second packet stream for insertion in an MPEG-2 transport stream.

8. An apparatus for providing a data interface protocol, the apparatus comprising:
packet input logic configured to receive a first packet stream comprising at least one overhead information symbol (OIS) group and at least one multicast logical channel (MLC) group;
packet processing logic configured to map each OIS group to an OIS descriptor packet and at least one OIS payload packet, and to map each MLC group to an MLC descriptor packet and at least one MLC payload packet; and
packet output logic configured to output the OIS descriptor packet, the at least one OIS payload packet, the MLC descriptor packet, and the at least one MLC payload packet in a second packet stream.

9. The apparatus of claim 8, wherein said packet input logic is configured to receive a MAC layer packet stream that comprises the at least one OIS group and the at least one MLC group.

10. The apparatus of claim 8, wherein said packet processing logic is configured to map the each OIS group to the OIS descriptor packet and five OIS payload packets.

11. The apparatus of claim 10, wherein said packet processing logic is configured to map the each OIS group to the OIS descriptor packet and the five OIS payload packets, wherein the OIS descriptor packets and the five OIS payload packets each comprise 181 bytes.

12. The apparatus of claim 8, wherein said packet processing logic is configured to map the each MLC group to an MLC descriptor packet and two MLC payload packets.

13. The apparatus of claim 12, wherein said packet processing logic is configured to map the each MLC group to the MLC descriptor packet and the two MLC payload packets, wherein the MLC descriptor packet and the two MLC payload packets each comprise 181 bytes.

14. The apparatus of claim 8, wherein said packet output logic is configured to output the second packet stream for insertion in an MPEG-2 transport stream.

15. An apparatus for providing a data interface protocol, the apparatus comprising:
means for receiving a first packet stream comprising at least one overhead information symbol (OIS) group and at least one multicast logical channel (MLC) group;
means for mapping each OIS group to an OIS descriptor packet and at least one OIS payload packet;
means for mapping each MLC group to an MLC descriptor packet and at least one MLC payload packet; and
means for outputting the OIS descriptor packet, the at least one OIS payload packet, the MLC descriptor packet, and the at least one MLC payload packet in a second packet stream.

16. The apparatus of claim 15, wherein said means for receiving comprises means for receiving a MAC layer packet stream that comprises the at least one OIS group and the at least one MLC group.

17. The apparatus of claim 15, wherein said means for mapping each OIS group comprises means for mapping the each OIS group to the OIS descriptor packet and five OIS payload packets.

18. The apparatus of claim 17, wherein said means for mapping each OIS group comprises means for mapping the each OIS group to the OIS descriptor packet and the five OIS payload packets, wherein the OIS descriptor packets and the five OIS payload packets each comprise 181 bytes.

19. The apparatus of claim 15, wherein said means for mapping each MLC group comprises means for mapping the each MLC group to an MLC descriptor packet and two MLC payload packets.

20. The apparatus of claim 19, wherein said means for mapping each MLC group comprises means for mapping the each MLC group to the MLC descriptor packet and the two MLC payload packets, wherein the MLC descriptor packet and the two MLC payload packets each comprise 181 bytes.

21. The apparatus of claim 15, wherein said means for outputting comprises means for outputting the second packet stream for insertion in an MPEG-2 transport stream.

22. A computer program product for providing a data interface protocol, comprising:
a machine-readable medium comprising:
a first set of codes for causing a computer to receive a first packet stream comprising at least one overhead information symbol (OIS) group and at least one multicast logical channel (MLC) group;
a second set of codes for causing the computer to map each OIS group to an OIS descriptor packet and at least one OIS payload packet;
a third set of codes for causing the computer to map each MLC group to an MLC descriptor packet and at least one MLC payload packet; and
a fourth set of codes for causing the computer to output the OIS descriptor packet, the at least one OIS payload packet, the MLC descriptor packet, and the at least one MLC payload packet in a second packet stream.

23. The machine-readable medium of claim 22, wherein said first set of codes is configured to receive a MAC layer packet stream that comprises the at least one OIS group and the at least one MLC group.

24. The machine-readable medium of claim 22, wherein said second set of codes is configured to map the each OIS group to the OIS descriptor packet and five OIS payload packets.

25. The machine-readable medium of claim 24, wherein said second set of codes is configured to map the each OIS group to the OIS descriptor packet and the five OIS payload packets, wherein the OIS descriptor packets and the five OIS payload packets each comprise 181 bytes.

26. The machine-readable medium of claim 22, wherein said third set of codes is configured to map the each MLC group to an MLC descriptor packet and two MLC payload packets.

27. The machine-readable medium of claim 26, wherein said third set of codes is configured to map the each MLC group to the MLC descriptor packet and the two MLC payload packets, wherein the MLC descriptor packet and the two MLC payload packets each comprise 181 bytes.

28. The machine-readable medium of claim 22, wherein said fourth set of codes is configured to output the second packet stream for insertion in an MPEG-2 transport stream.

29. At least one processor configured to perform a method for providing a data interface protocol, the at least one processor comprising:
a first module for receiving a first packet stream comprising at least one overhead information symbol (OIS) group and at least one multicast logical channel (MLC) group;
a second module for mapping each OIS group to an OIS descriptor packet and at least one OIS payload packet;
a third module for mapping each MLC group to an MLC descriptor packet and at least one MLC payload packet; and
a fourth module for outputting the OIS descriptor packet, the at least one OIS payload packet, the MLC descriptor packet, and the at least one MLC payload packet in a second packet stream.

30. The at least one processor of claim 29, wherein said first module is configured to receive a MAC layer packet stream that comprises the at least one OIS group and the at least one MLC group.

31. The at least one processor of claim 29, wherein said second module is configured to map the each OIS group to the OIS descriptor packet and five OIS payload packets.

32. The at least one processor of claim 31, wherein said second module is configured to map the each OIS group to the OIS descriptor packet and the five OIS payload packets, wherein the OIS descriptor packets and the five OIS payload packets each comprise 181 bytes.

33. The at least one processor of claim 29, wherein said third module is configured to map the each MLC group to an MLC descriptor packet and two MLC payload packets.

34. The at least one processor of claim 33, wherein said third module is configured to map the each MLC group to the MLC descriptor packet and the two MLC payload packets, wherein the MLC descriptor packet and the two MLC payload packets each comprise 181 bytes.

35. The at least one processor of claim 29, wherein said fourth module is configured to output the second packet stream for insertion in an MPEG-2 transport stream.

36. A method for providing a data interface protocol, the method comprising:
receiving a first packet stream comprising an overhead information symbol (OIS) descriptor packet, at least one OIS payload packet, a multicast logical channel (MLC) descriptor packet, and at least one MLC payload packet;
mapping the OIS descriptor packet and the at least one OIS payload packet to an OIS group;
mapping the MLC descriptor packet and the at least one MLC payload packet to an MLC group; and
outputting the OIS group and the MLC group in a second packet stream.

37. The method of claim 36, wherein said mapping the OIS descriptor packet comprises mapping the OIS descriptor packet and five OIS payload packets to the OIS group.

38. The method of claim 37, wherein said mapping the OIS descriptor packet comprises mapping the OIS descriptor packet and the five OIS payload packets to the OIS group, wherein the OIS descriptor packets and the five OIS payload packets each comprise 181 bytes.

39. The method of claim 36, wherein said mapping the MLC descriptor packet comprises mapping the MLC descriptor packet and two MLC payload packets to the MLC group.

40. The method of claim 39, wherein said mapping the MLC descriptor packet comprises mapping the MLC descriptor packet and two MLC payload packets to the MLC group, wherein the MLC descriptor packet and the two MLC payload packets each comprise 181 bytes.

41. The method of claim 36, wherein said outputting comprises outputting the OIS group and the MLC group in a MAC layer packet stream.
